(19) United States
(12) Patent Application Publication
(10) Pub. No.: US 2013/0102359 A1
(43) Pub. Date: Apr. 25, 2013

(54) SMART PHONE-COMBINABLE OTOLOGIC INSPECTION DEVICE

(71) Applicant: TIEN-HWA HO, New Taipei City (TW)

(72) Inventor: TIEN-HWA HO, New Taipei City (TW)

(21) Appl. No.: 13/277,231

(22) Filed: Oct. 20, 2011

(51) Int. Cl. H04W 88/02

(52) U.S. Cl. 455/556.1

(57) ABSTRACT

A smart phone-combinable otologic inspection device is composed of a smart mobile phone combined with an otologic inspection device. The otologic inspection device includes an optic inspection device and a light projection module. The optic inspection device includes at least one lens module for observation of interior of an ear. The image pickup module picks up at least one image through the optic inspection device and displays the image on the smart mobile phone. The light projection module is arranged in the optic inspection device and corresponds to the light source module. As such, an otologic inspection device is provided, which realizes integration of traditional optics and digitalization through combination with a smart mobile phone and allows of expansion of functionality.

### (a) TECHNICAL FIELD OF THE INVENTION

The present invention generally relates to an otologic inspection device, and more particularly to a smart phone-combinable otologic device that, when combined with a smart mobile phone, may integrate traditional optics and digitalization and allow of expansion of functionality.

### (b) DESCRIPTION OF THE PRIOR ART

Inspecting ears is an essential step of diagnosis of otology. However, in doing the diagnosis, due to the dark shaded situation inside the structure of ear, it is generally difficult to make observation with bare eyes. An otologic inspection device is often used in otologic diagnosis. The progress of science and technology also brings the conventional otologic inspection device functions of displaying and picking up image in a digitalized manner and may also allows of connection with an external display device, and this is currently prevailing.

However, the known otologic inspection devices receive certain criticisms from the users and in fact, the known inspection devices show the following general shortcomings that may be further improved:

(1) The known otologic inspection device is generally an electronic device that, after running out of electrical power, gets out of function totally and is no longer operable. Thus, when a user wishes to bring such a known otologic inspection to a site where electrical charging is generally not available, a spare set of otologic inspect device must be prepared. This is certainly troublesome.

(2) The known otologic inspection device is often completely set in respect of the functionality thereof and does not allow of addition of other functions.

### SUMMARY OF THE INVENTION

The primary objective of the present invention is to provide a solution to handle the problem that the known otologic inspection device gets out of function totally when running out of electrical power and a user, when making travel to a place where electrical charging is generally not available, must carry a spare set of otologic inspect device, and to realize a practical improvement of integrating the traditional optics and digitalization through selective combination with a smart mobile phone.

To achieve the above objective, the present invention provides a smart phone-combinable otologic inspection device, which comprises a smart mobile phone in combination with an otologic inspection device. The smart mobile phone comprises a control and drive module, which is electrically connected to a light source module, an image pickup module, a sound pickup module, and a display module. The control and drive module comprises a drive unit that controls the light source module, the image pickup module, the sound pickup module, and the display module. The otologic inspection device comprises an optic inspection device and a light projection module. The optic inspection device comprises at least one lens module for observation of interior of an ear. The lens module can be an ear inspection lens or an endoscope. The optic inspection device corresponds in position to the image pickup module, whereby the image pickup module can pick up at least one image through the optic inspection device and display the image on the smart mobile phone. The light projection module is arranged in the optic inspection device and corresponds to the light source module. The optic inspection device may comprise a light guide that allows of observation with bare eyes. The light projection module is connected to an independent light source.

Another objective of the present invention is to provide a solution to handle the problem that the existing otologic inspection devices are generally fixed in respect of functionality thereof and do not allow of addition of other functions, and to provide a practical improvement for expansion of functionality.

To achieve the above objective, the present invention provides a control and drive module that comprises an automatic inspection unit for preliminary diagnosis and the control and drive module may selectively comprises an electrical connector, which is electrically connected to an external display device, and the control and drive module may selectively comprise a network transmission unit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a first, preferred embodiment according to the present invention.

FIG. 2 is an exploded view of the preferred embodiment of the present invention.

FIG. 3 is a perspective view illustrating use of the preferred embodiment of the present invention.

FIG. 4 is a perspective view of a second embodiment according to the present invention.

FIG. 5 is a perspective view of a third embodiment according to the present invention.

FIG. 6 is a perspective view of a fourth embodiment according to the present invention.

FIG. 7 is a block diagram of the fourth embodiment according to the present invention.

FIG. 8 is a perspective view of a fifth embodiment according to the present invention.

FIG. 9 is a block diagram of a sixth embodiment according to the present invention.

FIG. 10 is a perspective view of a seventh embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

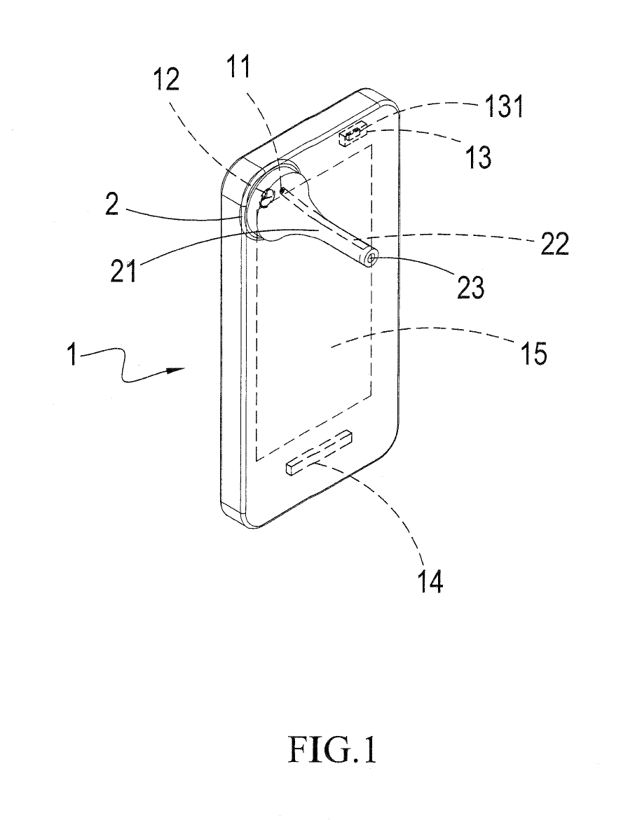

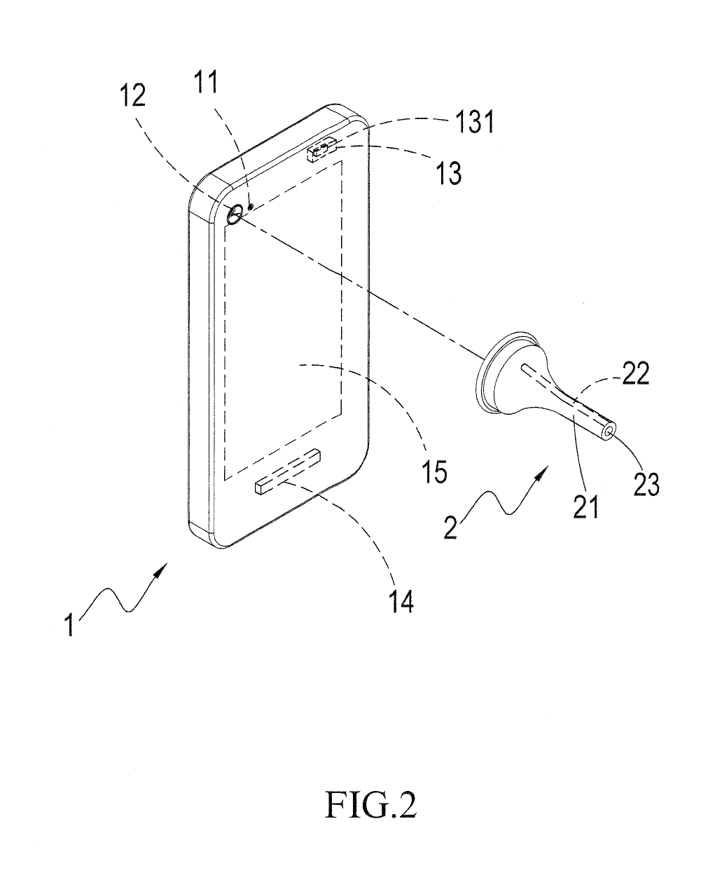

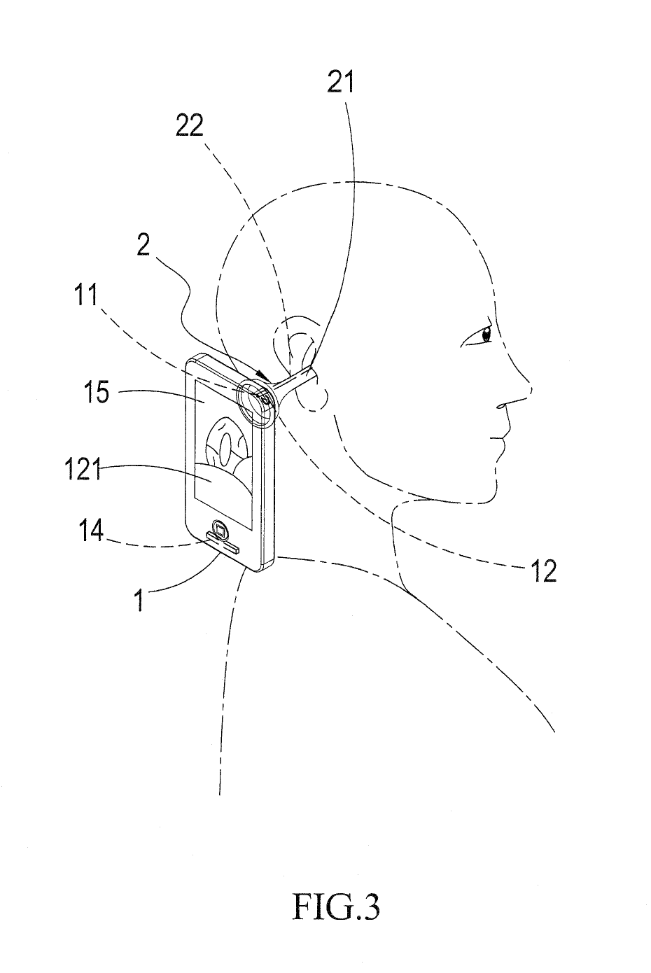

Referring to FIGS. 1, 2, and 3, which are respectively a perspective view and an exploded view of a preferred embodiment of the present invention, and a perspective view illustrating use of the present invention, these drawings clearly show that the present invention provides a smart phone-combinable otologic inspection device, which comprises a smart mobile phone 1 combined with an otologic inspection device. The smart mobile phone 1 comprises a control and drive module 13. The control and drive module 13 is electrically connected to a light source module 11, an image pickup module 12, a sound pickup module 14, and a display module 15. The control and drive module 13 comprises a drive unit 131 that controls the light source module 11, the image pickup module 12, the sound pickup module 14, and the display module 15. The otologic inspection device 2 comprises an optic inspection device 21. The optic inspection device 21 comprises at least one lens module 23 for observation of interior of an ear, where the lens module 23 can be an ear inspection lens, and the optic inspection device 21 corresponds in position to the image pickup module 12, whereby the image pickup module 12 may pick up at least one image 121 through the optic inspection device 21 and display the image 121 on the smart mobile phone 1; and a light projection module 22, which is arranged in the optic inspection device 21 and corresponds to the light source module 11.

With the arrangement discussed above, the operation of the preferred embodiment of the present invention will be described as follows. The drawings show that through combination of the smart mobile phone 1 that is currently popular and has excellent functionality with the otologic inspection device 2, the image pickup module 12 and the light source module 11 that are already included in the smart mobile phone 1 can work with pre-loaded application software to pick up an image of an observed site, with only addition of the otologic inspection device 2 in such a way that the optic inspection device 21 corresponds to the image pickup module 12 and the light projection module 22 corresponds to the light source module 11. The use is simple and easy and the costs of a display device that are required to be attached to the optic inspection device 21 can be saved, so that the overall cost is reduced, making the present invention economic.

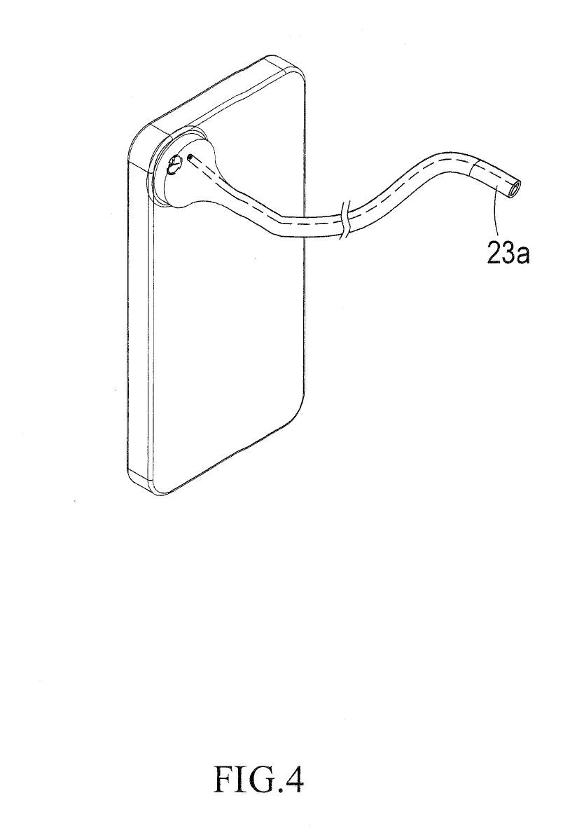

Referring to FIG. 4, which is a perspective view of a second embodiment according to the present invention, the drawing shows that the second embodiment is generally identical to the first embodiment in structure with the only difference being that the lens module 23a comprises an endoscope. Thus, when diagnosis requires the use of endoscope, the present invention can be used with an endoscope.

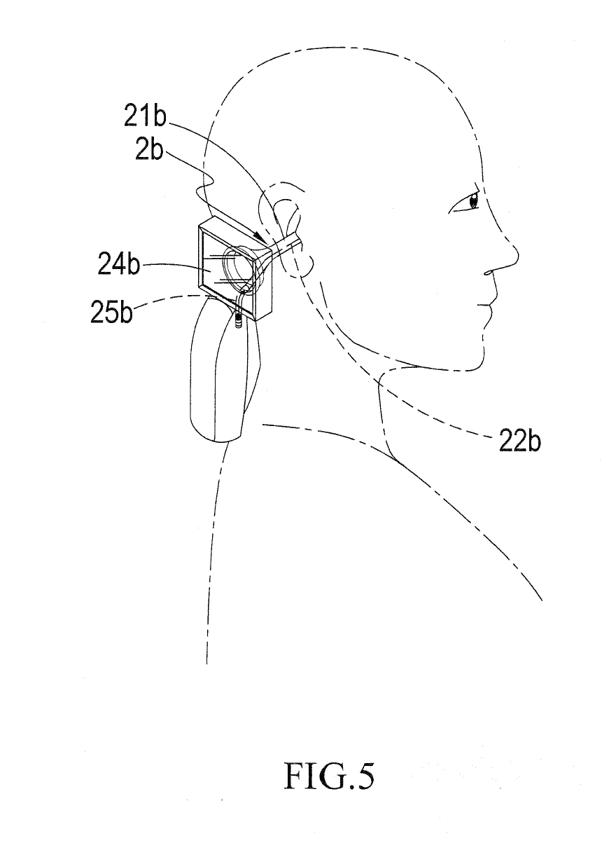

Referring to FIG. 5, which is a perspective view of a third embodiment according to the present invention, the drawing shows that the third embodiment is generally identical to the first embodiment in structure with the difference being that when the otologic inspection device 2b is used separately, the optic inspection device 21b is selectively provided with a light guide 24b that allows of observation with bare eyes. The light projection module 22b is connected to an independent light source 25b, so that the otologic inspection device 2b can be operated individually in a traditional way for carrying out inspection.

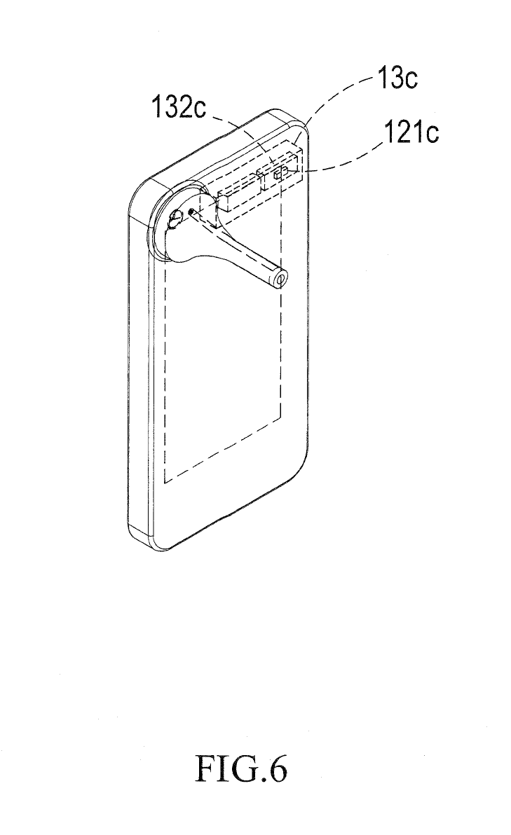

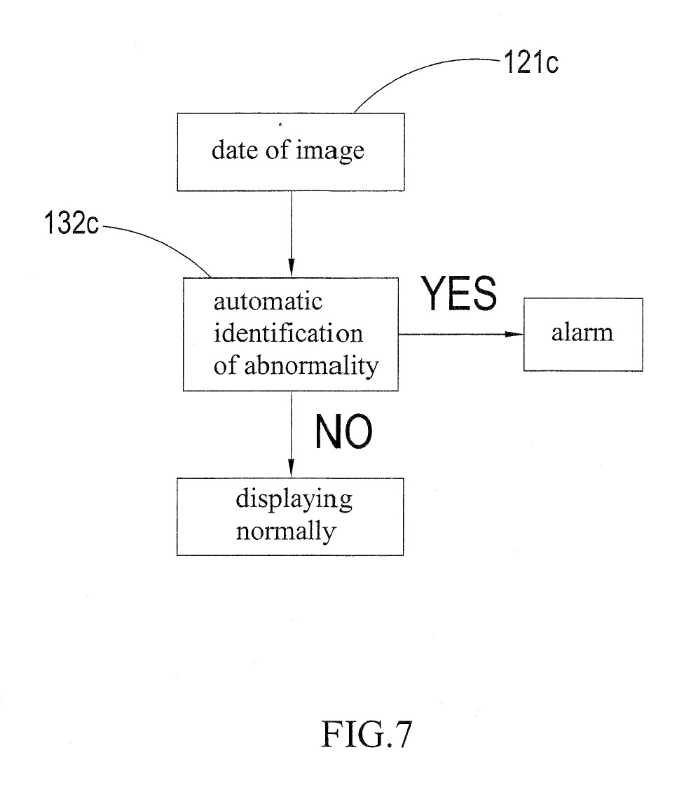

Referring to FIGS. 6 and 7, which are respectively a perspective view and a block diagram of a fourth embodiment according to the present invention, the drawings show that the fourth embodiment is generally identical to the first embodiment in structure with the difference being that the control and drive module 13c comprises an automatic inspection unit 132c for preliminary diagnosis. When an image 121c is supplied to the automatic inspection unit 132c, the automatic inspection unit 132c automatically performs inspection to determine if there is any abnormal situation. When identification of abnormality is determined, the automatic inspection unit 132c issues an alarm.

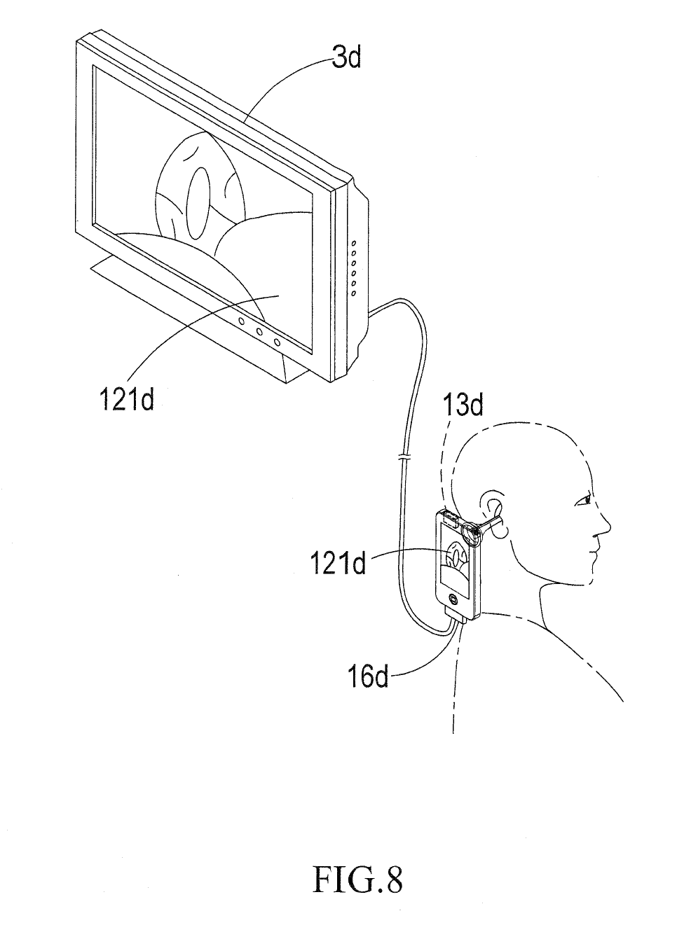

Referring to FIG. 8, which is a perspective view of a fifth embodiment according to the present invention, the drawing shows that the fifth embodiment is generally identical to the first embodiment in structure with the difference being that the control and drive module 13d comprises an electrical connector 16d and the electrical connector 16d is electrically connectable with an external display device 3d, whereby an image 121d that is received and processed by the smart mobile phone 1d can be transmitted to the external display device 3d.

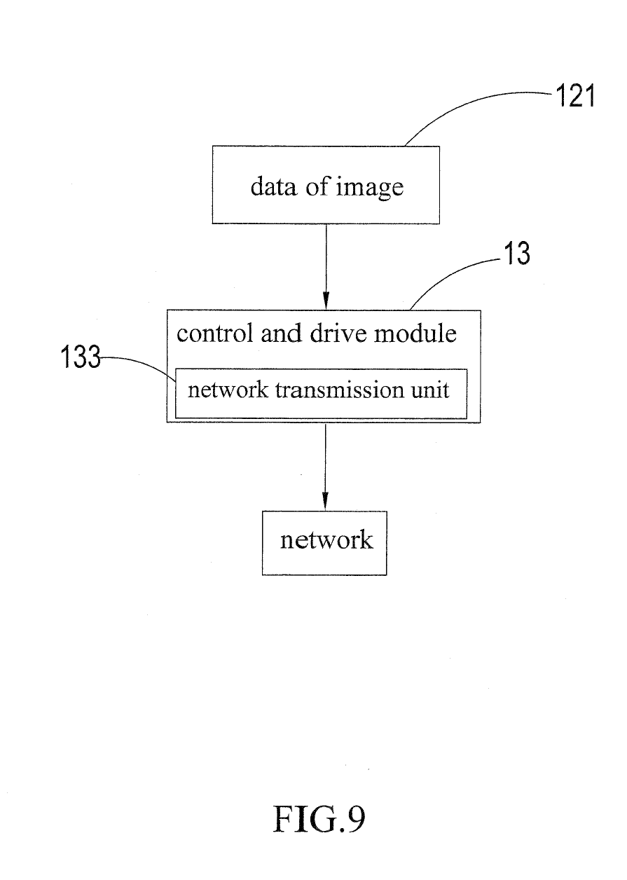

Referring to FIG. 9, which is a block diagram of a sixth embodiment according to the present invention, the drawing shows that the sixth embodiment comprises a network transmission unit 133 connected to the control and drive module 13e, whereby an image 121e can be transmitted through a network to allow of remote experts consultation or for educational purposes.

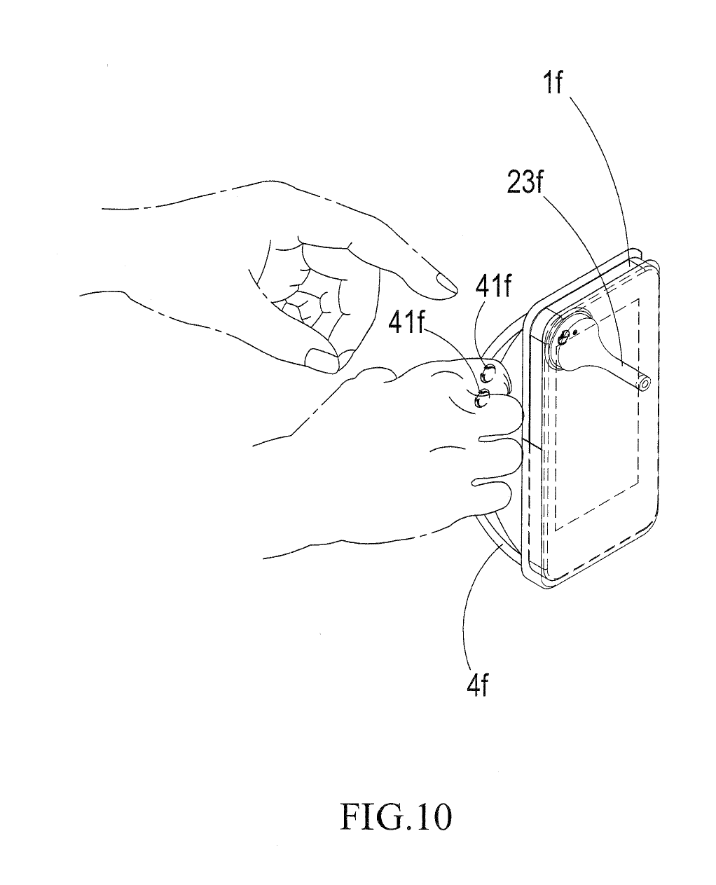

Referring to FIG. 10, which is a perspective view of a seventh embodiment according to the present invention, the drawing shows that the lens module 23f is connected to a handle 4f that is provided for accommodating the smart mobile phone 1f and also for easy gripping. The handle 4f may have a portion that is provided with a switch 41f in information connection with the smart mobile phone 1f for easy actuation to start recording or emit light.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A smart phone-combinable otologic inspection device, comprising a smart mobile phone in combination with an otologic inspection device, the smart mobile phone comprising a light source module and an image pickup module, wherein the otologic inspection device comprises:
an optic inspection device, which corresponds in position to the image pickup module, whereby the image pickup module is allowed to pick up at least one image through the optic inspection device and to display the image on the smart mobile phone; and
a light projection module, which is arranged in the optic inspection device and corresponds to the light source module.

2. The smart phone-combinable otologic inspection device according to claim 1, wherein the optic inspection device comprises at least one lens module for observation of interior of an ear.

3. The smart phone-combinable otologic inspection device according to claim 2, wherein the lens module comprises one of ear inspection lens and an endoscope.

4. The smart phone-combinable otologic inspection device according to claim 2, wherein the lens module is connected to a handle that accommodates the smart mobile phone and allows of easy gripping, the handle being provided with a switch in information connection with the smart mobile phone.

5. The smart phone-combinable otologic inspection device according to claim 1, wherein the optic inspection device comprises a light guide that allows of observation with bear eyes.

6. The smart phone-combinable otologic inspection device according to claim 1, wherein the light projection module is connected to an independent light source.

7. The smart phone-combinable otologic inspection device according to claim 1, wherein the smart mobile phone comprises a control and drive module, which is electrically connected to the light source module, the image pickup module, a sound pickup module, and a display module, the control and drive module comprising a drive unit that controls the light source module, the image pickup module, the sound pickup module, and the display module.

8. The smart phone-combinable otologic inspection device according to claim 7, wherein the control and drive module comprises an automatic inspection unit for preliminary diagnosis.

9. The smart phone-combinable otologic inspection device according to claim 7, wherein the control and drive module comprises an electrical connector, which is electrically connectable to an external display device.

10. The smart phone-combinable otologic inspection device according to claim 7, wherein the control and drive module comprises a network transmission unit.
